(19) United States
(12) Patent Application Publication
(10) Pub. No.: US 2024/0175697 A1
(43) Pub. Date: May 30, 2024

(54) METHOD AND DEVICE FOR LOCAL MAPPING, POSITIONING, AND GUIDANCE

(71) Applicants: Huili Yu, Fremont, CA (US); Yanling Yang, Fremont, CA (US)

(72) Inventors: Huili Yu, Fremont, CA (US); Yanling Yang, Fremont, CA (US)

(21) Appl. No.: 17/994,323

(22) Filed: Nov. 26, 2022

(51) Int. Cl. G01C 21/36; G01C 21/16; G01C 21/34

(52) U.S. Cl. CPC G01C 21/3617; G01C 21/16; G01C 21/3446; G01C 21/3644

(57) ABSTRACT

Systems and methods are provided for mapping, positioning, and guidance. An exemplary method may comprise: determining a path of a user associated with the computing device, the path comprising a plurality of historical local locations of the user; determining one or more critical points on the path; generating a back route to a target historical local location based on the one or more critical points; and guiding the user to the target historical local location based on the back route and the one or more critical points.

### TECHNICAL FIELD

This disclosure generally relates to artificial intelligence, and in particular, to method and device for local mapping, positioning, and guidance.

### BACKGROUND

Users may often encounter unfamiliar environment in their daily activities, such as outdoor adventures, traveling to attractions that have not been visited before, shopping in new shopping malls, driving to some unfamiliar towns, and so on. Finding a way back to their original locations or some interesting places along the way they come can be critical for them to safely and efficiently navigate in the unfamiliar environment without getting lost. Traditionally, to find a way back to their past locations, users may have to memorize the places they visited and the paths from the places in their minds or rely on global positioning tools such as Global Positioning System (GPS).

However, it may not be easy for users to memorize the paths especially in such environments as mountain areas, complex urban areas, and supermalls, etc. In addition, some users like children, elderlies, and disabled people may not even remember places or paths in the environments they are familiar with. On the other hand, the global positioning tools often require radio connection to operate, which may not be accessible in some environments or is expensive or risky to use. Therefore, technologies assisting people to find their way back without the help of global positioning is in an urgent need.

### SUMMARY

Various embodiments of the present disclosure can include systems, methods, and non-transitory computer readable media for local mapping, positioning, and guidance. According to one aspect, a method for mapping, positioning, and guidance may comprise: determining a path of a user associated with the computing device, the path comprising a plurality of historical local locations of the user; determining one or more critical points on the path; generating a back route to a target historical local location based on the one or more critical points; and guiding the user to the target historical local location based on the back route and the one or more critical points.

According to another aspect, an apparatus for mapping, positioning, and guidance may comprise a processor and a non-transitory computer-readable storage medium storing instructions that, when executed by the processor, cause the apparatus to perform a method. The method may comprise: determining a path of a user associated with the computing device, the path comprising a plurality of historical local locations of the user; determining one or more critical points on the path; generating a back route to a target historical local location based on the one or more critical points; and guiding the user to the target historical local location based on the back route and the one or more critical points.

According to yet another aspect, a non-transitory computer-readable storage medium may store instructions that, when executed by a processor, cause the processor to perform a method. The method may comprise: determining a path of a user associated with the computing device, the path comprising a plurality of historical local locations of the user; determining one or more critical points on the path; generating a back route to a target historical local location based on the one or more critical points; and guiding the user to the target historical local location based on the back route and the one or more critical points.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an exemplary environment for local mapping, positioning, and guidance, in accordance with various embodiments.

FIG. 2A illustrates a schematic diagram showing an example of a deep neural network for classifying motions of a computing devices, in accordance with various embodiments.

FIGS. 2B-2E illustrate a schematic diagram showing examples of a network for predicting a location and heading of the computing device, in accordance with various embodiments.

FIGS. 2F and 2G illustrate a schematic diagram showing examples of a network for classifying whether a location is a critical point or non-critical point, in accordance with various embodiments.

FIGS. 2H and 2I illustrate a schematic diagram showing examples of a network for both prediction of a location and heading of the computing device and classification of a location as critical point or non-critical point, in accordance with various embodiments.

FIG. 2J illustrates a schematic diagram showing an example for training an IMU-based model (student model) for predicting location and/or heading and location classification using knowledge distillation, in accordance with various embodiments.

FIG. 2K illustrates a schematic diagram showing a relation between a time window t_{w} and a time period Δt over which a location change or update, a distance change or update, a heading change, a velocity vector, or a speed and angular velocity vector may be predicted, in accordance with various embodiments.

FIG. 3 illustrates a schematic diagram showing a previous critical point, a current critical point, a next critical point, and a target point on a back route along which a user associated with the computing device is moving, in accordance with various embodiments.

FIG. 4A illustrates a schematic diagram showing an example for determining a switch from a current critical point to a next critical point based on a current location of the computing device and a current critical point, in accordance with various embodiments.

FIG. 4B illustrates a schematic diagram showing an example of criteria for determining a switch from a current critical point to a next critical point based on a geometry relationship among a current location of the computing device, a current critical point, and a next critical point, in accordance with various embodiments.

FIG. 5 illustrates a flowchart of an exemplary method for local mapping, positioning, and guidance, in accordance with various embodiments.

FIGS. 6A-6B illustrate a flowchart of another exemplary method for local mapping, positioning, and guidance, in accordance with various embodiments.

FIG. 7 illustrates a block diagram of an exemplary computer system in which any of the embodiments described herein may be implemented.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Users may often encounter unfamiliar environment in their daily activities, such as outdoor adventures, traveling to attractions that have not been visited before, shopping in new shopping malls, driving to some unfamiliar towns, and so on. Finding a way back to their original locations or some interesting places along the way they come can be critical for them to safely and efficiently navigate in the unfamiliar environment without getting lost. Traditionally, to find a way back to their past locations, users may have to memorize the places they visited and the paths from the places in their minds or rely on global positioning tools such as Global Positioning System (GPS).

However, it may not be easy for users to memorize the paths especially in such environments as mountain areas, complex urban areas, and supermalls, etc. In addition, some users like children, elderlies, and disabled people may not even remember places or paths in the environments they are familiar with.

Further, the GPS-based navigations often require radio connection to work, which may not be accessible in some environments or is expensive or risky to use. A computing device, like a cell phone, is equipped with a GPS receiver that receives GPS signals about users' locations in a prebuilt map. Based on the locations and the prebuilt map, the users are able to find their paths to their destinations. However, in many areas, such as mountains, suburban areas, urban environment with many tall buildings, etc., GPS signals are unstable or even missing. Further, many mountain and suburban areas are unmapped. In addition, the GPS signals are not available in indoor environments. These cause the GPS-based navigations to fail.

Another drawback of the GPS-based navigations using GPS signals and prebuilt maps in computing devices (e.g., cell phones) is that the users must rely on map software providers, e.g., Google map provider—Google™. Using this positioning solution provided by map software providers will have potential privacy risks for users.

Other work attempts to rely on Simultaneous Localization and Mapping (SLAM) or Visual-Inertial Odometry (VIO) techniques to build a map about the environment and perform localization in the map. Using measurements from various sensors, such as monocular camera, stereo camera, IMU, Lidar, RGBD sensor, etc., the SLAM/VIO techniques are capable of providing high precision localization and therefore has been used in the fields of autonomous driving and robotics. However, the high computation cost of the SLAM/VIO techniques hinders their use in computing devices which have limited computing resource, like cell phones or wearable devices. Further, due to the size and weight limitation, some computing devices, like wearable devices, are not equipped with many sensors, like camera, Lidar, RGBD sensor. In addition, even though cell phones have been equipped with cameras, it is power consuming and inconvenient for users to use them for navigation because the users need to hold the cell phones and use the cameras to sense the environments all the time.

No existing methods provide a light-weight solution for assisting people to find a way back to their historical locations using resource-limited computing devices, such as cell phones or wearable devices, etc. On the other hand, most of computing devices are equipped with IMU. It is desirable to develop an IMU-based solution to assist users to find a way back to the users' historical locations. In some embodiments, the IMU-based solution may only need the measurements of the onboard IMU equipped in a computing device and therefore is light-weight and cheap. In addition, the IMU-based solution is convenient to use because users can take the computing device with them, such as in the pocket, bag, etc., or attach in their arms without having to hold them to sense the environment all the time. Therefore, the proposed solution of finding a way back to historical locations using IMU-based technique provides an elegant way to help various users (e.g., children, elderlies, and disabled people) travel in various environments without a need for GPS or radio connection. The proposed solution can apply not only to walking or running users, but also to robots, vehicles, or air vehicles navigating in various environments. The IMU-based solution can save computational costs or other resources for the robots, vehicles, or air vehicles to operate and navigate.

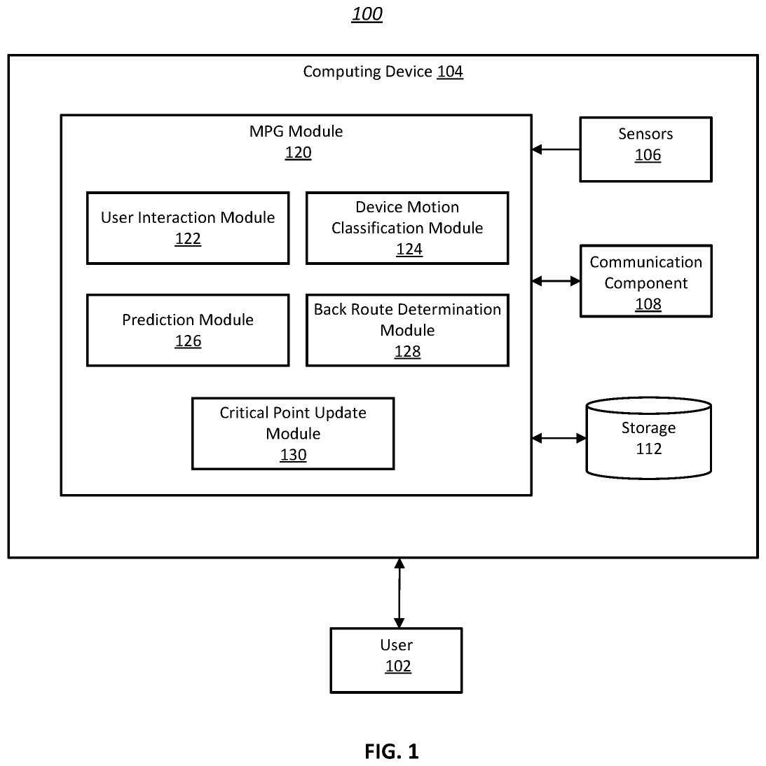

FIG. 1 illustrates an exemplary environment 100 for local mapping, positioning, and guidance, consistent with exemplary embodiments of the present disclosure. As shown in FIG. 1, the exemplary environment 100 may include a computing device 104. For example, the computing device 104 may be a mobile phone, a smart watch or any other wearable device, a tablet, etc. In some embodiments, the computing device 104 may be any device that are portable by users 102 and have some capability of computing. In other embodiments, the computing device 104 may be a device configured on a robot, a vehicle, or an air vehicle to enable or facilitate the navigation of the robot, vehicle or air vehicle.

In some embodiments, the computing device 104 may be configured to interact with or be controlled by the users 102. In some embodiments, the users 102 may interact with the computing device 104 to navigate in some environment. For example, a user 102 may interact with the computing device 104 through a user interface (e.g., a GUI) of an application (e.g., a mapping, positioning, and guidance app) on the computing device 104. In another example, the computing device 104 may receive inputs or instructions from the user 102 by various ways, e.g., by monitoring and capturing the user's 102 actions applied to the computing device 104, such as hand motion and arm motion, etc., by receiving voice inputs of the user 102, or by text inputs of the user 102. The computing device 104 may send signals or instruction to the user 102, e.g., warning signals to the user 102 such as voice or vibration signals to warn the user 102 of wrong direction or being off the current route, or guidance instructions such as turning right or left, keeping on the current road, turning around, taking the first/second/third route to the left, take the first/second/third route to the right, etc.

In the illustrated embodiments, the computing device 104 may include a mapping, positioning, and guidance module 120, sensors 106, a communication component 108, and a storage 112. The mapping, positioning, and guidance module 120 may be connected with the other components of the computing device 104, e.g., the sensors 106, the communication component 108, and the storage 112, to retrieve sensor measurements about the environment and user instructions from the user 102 via the communication component 108, and to generate and send guidance instructions to the user 102. The mapping, positioning, and guidance module 120 may include one or more processors coupled with the storage 112 such as memory (e.g., permanent memory, temporary memory, flash memory) or disk. The processor(s) may be configured to perform various operations by executing machine-readable instructions stored in the memory. The mapping, positioning, and guidance module 120 may include other computing resources and/or have access (e.g., via one or more connections/networks) to other computing resources. The mapping, positioning, and guidance module 120 may include an application (app) operative on the computing device 104, etc. For the ease and conciseness of description, the mapping, positioning, and guidance module 120 may be referred to as MPG module 120 hereinafter.

While the MPG module 120 is shown in FIG. 1 as a single entity, this is merely for ease of reference and is not meant to be limiting. In some embodiments, one or more components/functionalities of the MPG module 120 described herein may be implemented in multiple MPG modules.

The sensors 106 may include sensors that measure velocity and acceleration of the computing device 104. For example, the sensors may include IMU sensors. The computing device 104 (e.g., one or more modules associated with the sensors 106) may receive measurements from the IMU sensors equipped on the computing device 104. In some embodiments, the measurements include three-axis angular velocity from a three-axis gyroscope and three-axis acceleration from a three-axis accelerometer. In some other embodiments, the sensors may also include a GPS receiver, a camera, or both. The measurements may include the GPS data from the GPS receiver equipped on the computing device 104 and images from cameras equipped on the computing device 104.

The MPG module 120 may include a user interaction module 122, a device motion classification module 124, a prediction module 126, a back route determination module 128, and a critical point update module 130. In some embodiments, the MPG module 120 may operate in two modes: a mapping mode and a guidance mode. In the mapping mode, the MPG module 120 may detect one or more trajectories or paths of the user 102 moving in an environment and determine critical points along the trajectories or paths of the user 102. A path of a user 102 may include one or more current and historical local locations of the user 102. A trajectory of a user may include both one or more current and historical local locations of the user 102 and time associated with the one or more current and historical locations. In some embodiments, the mapping mode may be used as the default model once the MPG module 120 starts running.

Critical points are locations that are critical to the navigation of the user 102. For example, critical points may include turning points, intersections of multiple routes/paths, landmarks including traffic signs and trees, and any other meaningful points that may help the navigation back to any of the locations that the user 102 has visited or passed by in a current trip. In some embodiments, the critical points are determined as the points along the determined trajectories that can guide the users 102 to reach historical locations selected by the users 102 by following the points sequentially. In some embodiments, the critical points may be the locations close to an area (e.g., within a distance, such as 0.5 meters, 1 meter, 1.5 meters, 2 meters, 5 meters, etc., from the area) where there are two or more options of traveling (e.g., intersections between two or more hallways, trails, streets, and roads, etc.). In some embodiments, the critical point may be the locations close to areas (e.g., within a distance, such as 0.5 meters, 1 meter, 1.5 meters, 2 meters, 5 meters, etc., from the area) where a change of traveling direction is greater than a degree (e.g., 30, 45, 60, 90, 135, or other value of degree). In some embodiments, the critical points may be the locations close to landmarks that facilitate the users 102 to remember the routes they travelled in the mapping mode (e.g., within a distance, such as 0.5 meters, 1 meter, 1.5 meters, 2 meters, 5 meters, etc., from the landmarks). The landmarks may include, but are not limited to, traffic signs, road signs, road objects, and any other indoor or outdoor objects with special shape, color, and other information standing out from the environment. Furthermore, the critical points may also be the locations close to landmarks that help the user 102 to navigate back (e.g., within a distance, such as 0.5 meters, 1 meter, 1.5 meters, 2 meters, 5 meters, etc., from the landmarks). The landmarks may include, but are not limited to, traffic signs, road objects, road sign, or any objects standing out from the environment.

In the guidance mode, the MPG module 120 may guide back to target historical locations for a user 102. For example, the MPG module 120 may enable a user 102 to select a target historical location that the user 102 has passed by or visited and the MPG module 120 determines a back route to the selected historical location for the user 102. In some embodiments, the target historical location may be the original location of the user 102 by default. In other embodiments, the target historical location may be any of the historical locations that the user 102 has visited and likes to go back to revisit (e.g., an interesting attraction, an interesting shopping store, etc.).

In some embodiments, the MPG module 120 may receive measurements (e.g., IMU measurements, device motions, etc.) from the sensors 106, determine an operation mode (e.g., a mapping mode, a guidance mode) and/or one or more trajectories or paths of users 102, and determine critical points along the determined trajectories or paths of the user 102 in a mapping mode. In some embodiments, the MPG module 120 may further store the determined user trajectories or paths and critical points in the computing device 104 (e.g., in the storage 112), and in a guidance mode, generate a back route to target historical locations selected by the users 102 based on the stored critical points as well as the stored historical trajectories or paths of the users 102. The back route consists of the current location of the users 102 and stored critical points and target historical locations which the users 102 like to revisit. In the guidance mode, the MPG module 120 may determine a switch from a current critical point to a next critical point along the back route based on a current location of the user 102 so that the MPG module 120 may update the back route and/or provide updated guidance to the user 102. For example, when determining a switch from a current critical point to a next critical point, the MPG module 120 may update the back route by changing the next critical point to the current critical point, and generate instructions to guide the users 102 to the updated current critical point. Description of the above functionalities and processes of the MPG module 120 will be provided in further detail with reference to the modules 122, 124, 126, 128, 130.

The user interaction module 122 may receive inputs from a user 102 via the sensors 106, and respond to the user 102 based on the inputs. In some embodiments, the user interaction module 122 may send some signals or guidance instructions to the user 102. For example, the user interaction module 122 may display the navigation or route information to the user 102, send a warning signal to indicate that the user 102 is off the currently planned path, etc.

In some embodiments, the user interaction module 122 may enable the user 102 to switch between a mapping mode and a guidance mode. In some embodiments, the user interaction module 122 may retrieve a mode signal from the user 102 through a GUI of the computing device 104. The mode signal may indicate a selection of the user 102 with respect to a mapping mode, or a guidance mode. For example, the GUI may allow the user 102 to specify a mapping mode or a guidance mode and send a mode signal indicating the mode selected by the user 102 to other modules 124, 126, 128, 130. In other embodiments, the user interaction module 122 may retrieve the mode signal by receiving voice of the user 102. In some embodiments, the user interaction module 122 may receive data (e.g., velocity data, acceleration data, etc.) from the sensors 106 (e.g., IMUs) that capture the motion of the computing device 104 conducted by the user's 102 that indicates a switch between a mapping mode and a guidance mode. For example, a motion of the computing device 104 that indicates a selection of a mapping mode or a guidance mode may include up-to-down motion, down-to-up motion, circular motion, and any other kinds of motion in a vertical plane parallel to the walking direction of the user 102. In another example, a predefined motion of the computing device 104 that indicates a switch between a mapping mode and a guidance mode may also include up-to-down motion, down-to-up motion, left-to-right motion, right-to-left motion, triangular motion, circular motion, rectangular motion, and any other kinds of motion in other planes, like a vertical plane perpendicular to the walking direction of the user 102, a horizontal plane, and a plane with some angle from the walking direction of the user 102.

In some embodiments, the user interaction module 122 may receive data (e.g., velocity data, acceleration data, etc.) from the sensors 106 (e.g., IMUs) that capture the motion of the computing device 104 conducted by the user's 102 that indicates a critical point (e.g., a landmark, a turn, etc.) or a target historical point the user 102 likes to revisit (e.g., the original location of the user, an interesting attraction, an interesting shopping store, etc.). For example, a motion of the computing device 104 that indicates a critical point or a target historical point may include up-to-down motion, down-to-up motion, circular motion, and any other kinds of motion in a vertical plane parallel to the walking direction of the user 102. In another example, a predefined motion of the computing device 104 that indicates to add a critical point or a target historical point may also include up-to-down motion, down-to-up motion, left-to-right motion, right-to-left motion, triangular motion, circular motion, rectangular motion, and any other kinds of motion in other planes, like a vertical plane perpendicular to the walking direction of the user 102, a horizontal plane, and a plane with some angle from the walking direction of the user 102. The motion indicating a critical point and the motion indicating a target historical point may be different. In some embodiments, the user interaction module 122 may receive other data (e.g., video data, image data, etc.) from the sensors 124 (e.g., a camera) that capture the gesture of the user 102 indicating a critical point or a target historical point and send the inputs to other modules, e.g., the device motion classification module 124, or the predication module 126, for processing the inputs to provide guidance information back to the user 102. In other embodiments, the user interaction module 122 may enable the user 102 to add critical points or target points through a user interface or through voice input to the computing device 104.

In some embodiments, the user interaction module 122 may also receive data that capture a predefined set of motions of the computing device 104 conducted by the user 102 indicating a switch from a current critical point to a next critical point. For example, a predefined motion of the computing device 104 that indicates a switch from a current critical point to a next critical point may include up-to-down motion, down-to-up motion, circular motion, and any other kinds of motion in a vertical plane parallel to the walking direction of the user 102. In another example, a predefined motion of the computing device 104 that indicates a switch from a current critical point to a next critical point may also include up-to-down motion, down-to-up motion, left-to-right motion, right-to-left motion, triangular motion, circular motion, rectangular motion, and any other kinds of motion in other planes, like a vertical plane perpendicular to the walking direction of the user 102, a horizontal plane, and a plane with some angle from the walking direction of the user 102. In other embodiments, the user interaction module 122 may enable the user 102 to indicate a switch from a current critical point to a next critical point through a user interface or through voice input, video input, or image input to the computing device 104.

In some embodiments, the user interaction module 122 may send the received data to the device motion classification module 124 to recognize instructions indicated by the motion of the computing device 104 caused by the user 102, and send the instructions to the other modules 126, 128, 130.

The device motion classification module 124 may classify the motion of the computing device 104 into one of a set of predefined functionalities by using machine learning and deep learning approaches. The device motion classification module 124 may include a deep neural network using 1D CNN, RNN/LSTM, self-attention, transformer, etc., to classify the motion of the computing device 104. If the motion of the computing device 104 is classified as a mapping mode or a guidance mode, the device motion classification module 124 may send the mode signal indicating the classified mode to one or other modules 126, 128, 130 to switch to the classified mapping or guidance mode.

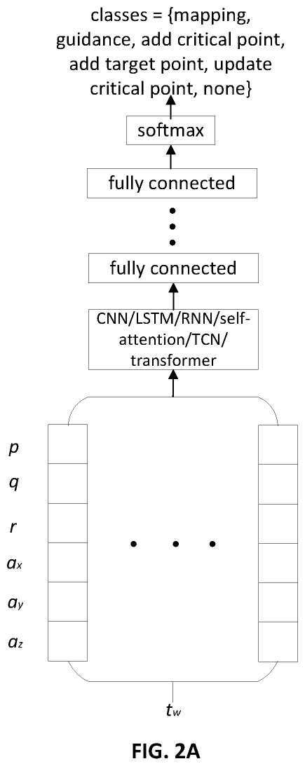

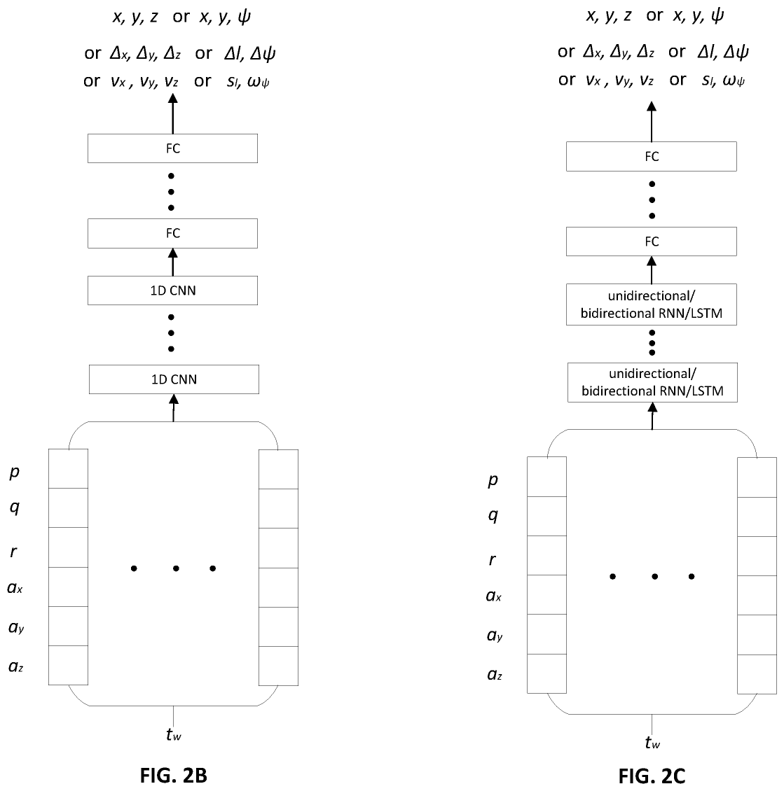

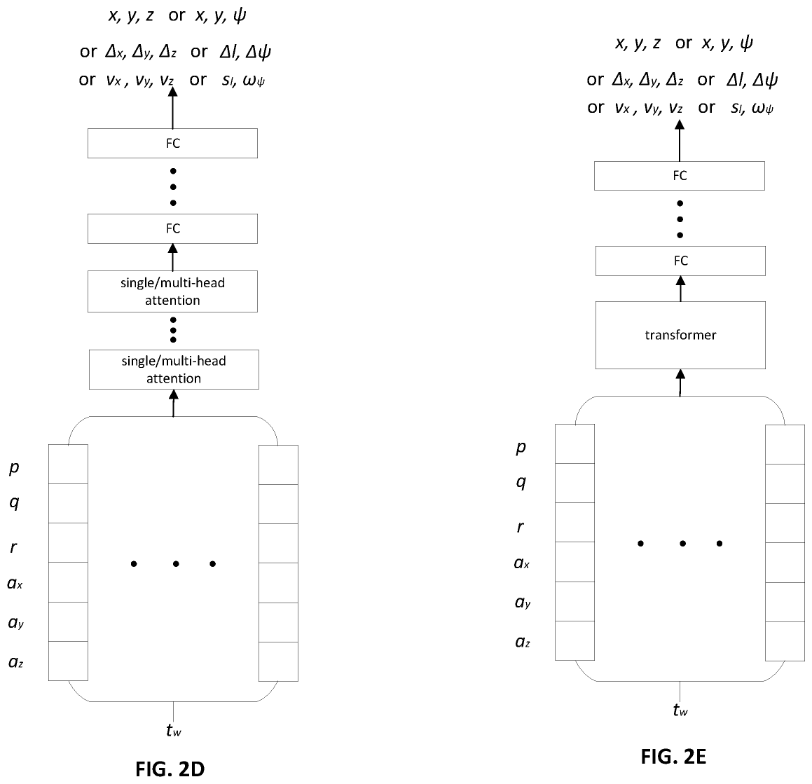

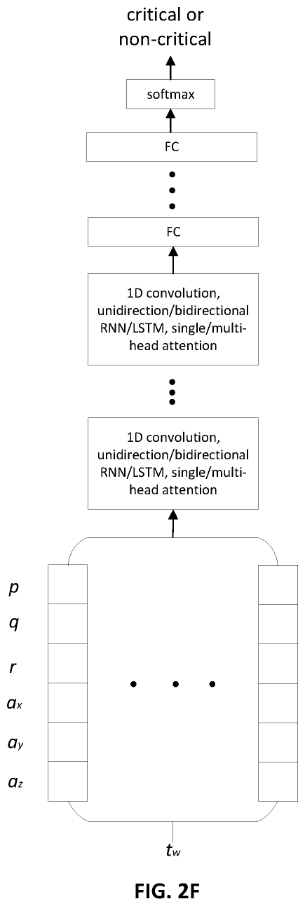

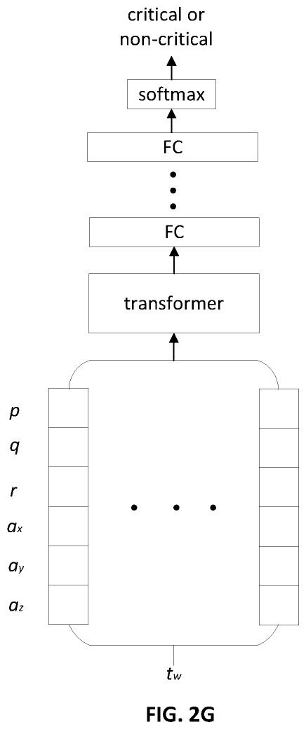

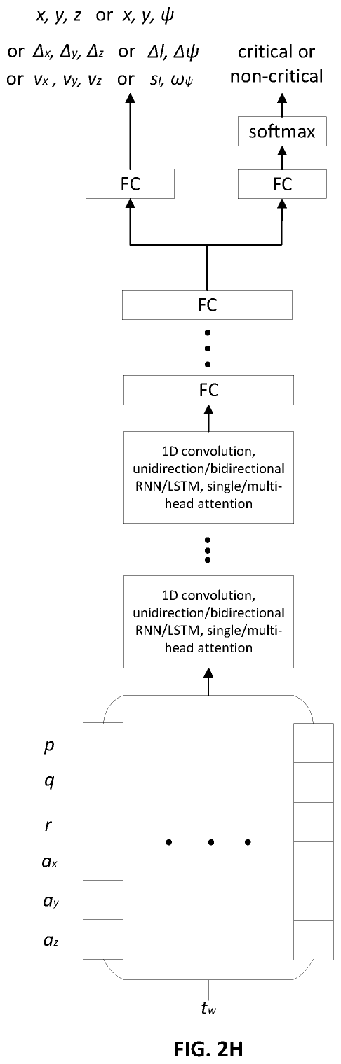

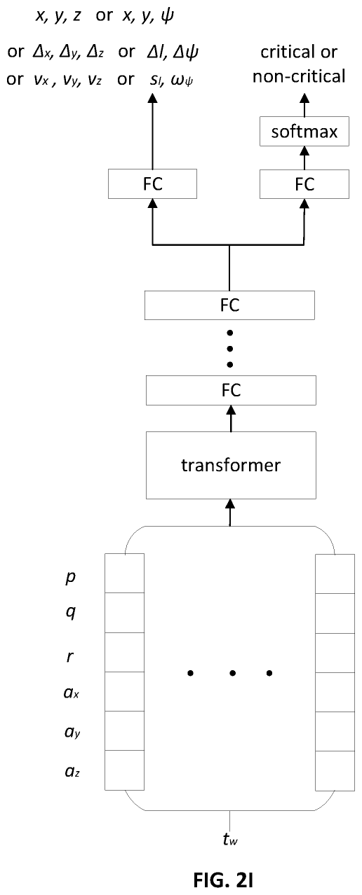

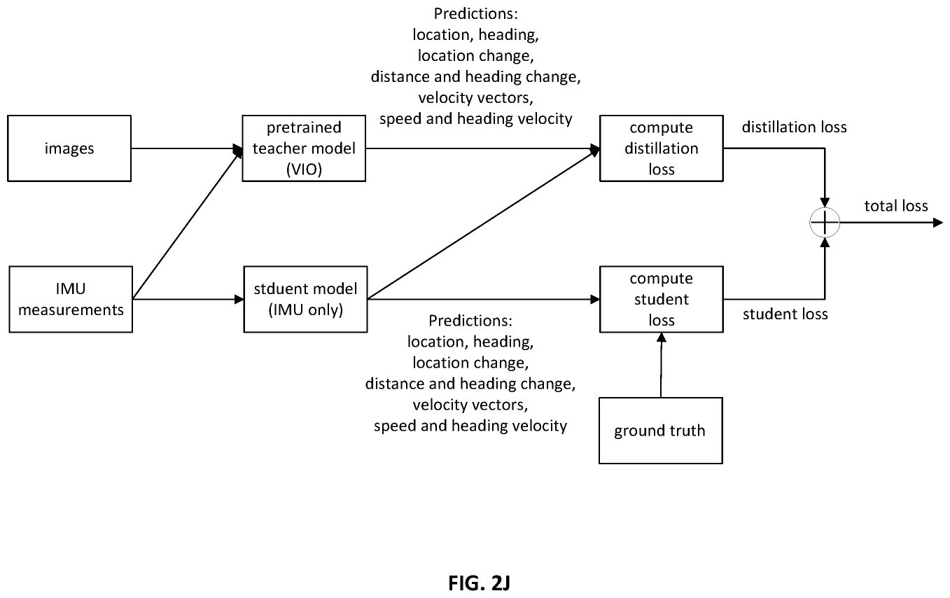

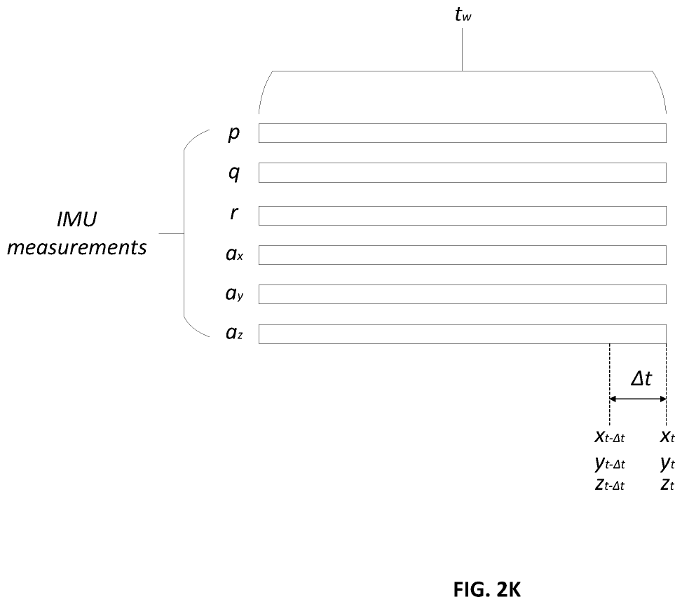

FIG. 2A shows an example of a deep neural network, which may be used to classify the motions of the computing device 104 conducted by the users 102 and/or other items described below with reference to other modules 124, 126, 128, 130, into a set of predefined functionalities. In the example deep neural network in FIG. 2A, p, q, r are angular velocities in x, y, z axes of a device body frame (IMU frame), aₓ, a_{y}, a_{z} are accelerations in x, y, z axes of the device body frame, t_{w} is the time window during which all the IMU measurements up to a current time instant are inputs to the deep neural network to classify a motion of the user 102 on the computing device 104. In the example shown in FIG. 2A, the deep neural network may include one or more one-dimensional (1D) Convolutional Neural Networks (CNNs), one or more pooling layers, one or more dropout layers, or more normalization layers, like batch normalization, group normalization, and layer normalization, etc., one or more unidirectional or bidirectional Long Short Term Memory (LSTM) networks or Recurrent Neural Networks (RNNs), one or more single or multi-head self-attention networks, one or more Temporal Convolutional Networks (TCNs), one or more fully connected networks, one or more softmax layers, one or more transformer networks, and any combination of the networks thereof.

The device motion classification module 124 may also classify the motion of the computing device 104 conducted by the user 102 to determine critical points, target historical points the user 102 likes to revisit, and to determine a switch from a current critical point to a next critical point. The user interaction module 122 may send data from the sensors 106 capturing the motion of the computing device 104 to the device motion classification module 124 to classify the motion of the computing device 104 to determine whether the motion of the computing device 104 indicates that the user 102 adds the current location as a critical point or a target point, or a switch from a current critical point to a next critical point.

In some embodiments, determining a switch from a current critical point to a next critical point includes determining whether a motion of the computing device 104 indicates the location of the computing device 104 is within a predetermined range from the current critical point. When determining that the motion of the computing device 104 indicates the location of the computing device 104 is within a predetermined range from the current critical point, the device motion classification module 124 may determine a switch from a current critical point to a next critical point. For example, when a user 102 holding the computing device 104 (or keeping the computing device 104 in a backpack or shoulder bag with the user 102 alternatively) is close enough (e.g., within a range) to a location in the environment, which leads to multiple options of travelling, like an intersection or a turn, or close enough to a landmark in the environment, which the user 102 has visited, and for which the user 102 does not receive guidance hints or instructions about the next step from the computing device 104, the user 102 may conduct an action on the computing device 104 to cause a motion of the computing device 104 indicating a switch from a current critical point to a next critical point.

In some embodiments, the user interaction module 122 and/or the device motion classification module 124 may store critical points and target points in a mapping mode. In some embodiment, the user interaction module 122 may receive inputs from a user 102 to update the current critical point in a guidance mode. For example, the inputs from the user 102 may include voice of the user 102 or inputs on a user interface by the user 102. In other examples, the inputs may include a motion of the computing device 104 caused by action of the user 102. The user interaction module 122 and the device motion classification module 124 may detect and classify the motion of the computing device 104 by a deep neural network. The network may be constructed using Recurrent Neural Network (RNN), Long Short Term Memory (LSTM), one dimensional Convolutional Neural Network (CNN), pooling, batch normalization, dropout, fully connected layers, softmax, TCN, self-attention, transformer, and combinations of these network architectures thereof. One example of such a network is shown in FIG. 2A as described above. In some embodiments, if a switch from a current critical point to a next critical point is determined, the current location of the user 102 may be updated or reset as the location of the current critical point that is being switched from.

The predication module 126 may determine historical trajectory or path of a user 102 and provide the determined historical trajectory or path to other modules 128, 130. In some embodiments, the predication module 126 may predict a current location of the user 102 during navigation in either a mapping mode or a guidance mode. In some embodiments, the prediction module 126 may predict critical points along a historical trajectory or path of user in the mapping mode. In some embodiments, the predication module 126 may use deep learning techniques or machine learning techniques to predict the current location of the user 102, determine the historical trajectory or path for the user 102 including historical locations of the user 102, and predict critical points along the one or more historical trajectories or paths.

In some embodiments, the predication module 126 may retrieve IMU measurements from sensors 106 as inputs through the user interaction module 122, predict or estimate a location and/or heading of a user 102 associated with the computing device 104, and classify the location as a critical point or a non-critical point. In some embodiments, the coordinate frame for the location and/or heading may be East-North-Up (ENU) frame, where x axis is directed East, y axis is directed North, z axis is directed up, and the origin is set at the original location (home). In other embodiments, the coordinate frame may be North-East-Down (NED) frame, where x axis is directed North, y axis is directed East, z axis is directed toward the center of the earth or down, and the origin is set at the original location (home). In yet other embodiments, z axis is directed up or down and x axis and y axis are not restricted to be aligned with East-North (ENU) and North-East (NED), and they can be directed to any direction in the horizontal plane while maintaining perpendicular to each other.

In some embodiments, the predication module 126 may include two separate deep learning models for predicting location and/or heading and performing critical point classification. For example, the predication module 126 may use one deep learning model for predicting the user location and/or heading, and use another deep learning model to classify whether the location is the critical point or non-critical point.

The deep learning model for predicting location and/or heading may be constructed using Recurrent Neural Network (RNN), Long Short Term Memory (LSTM), one dimensional Convolutional Neural Network (CNN), pooling, batch normalization, dropout, fully connected layers, TCN, self-attention, transformer, and combinations of network architectures thereof. In some embodiments, the predictions may be an absolute location and/or heading at a current time instant. In other embodiments, the predictions may be a location change or update over a time period Δt (e.g., with a predetermined length such as 0.01, 0.02, 0.05, 0.1 seconds, etc.) in a Cartesian coordinate. In yet other embodiments, the predictions may be a distance change or update and a heading change over a predetermined time period Δt (e.g., with a predetermined length such as 0.01, 0.02, 0.05, 0.1 seconds, etc.) in a polar coordinate. In still other embodiments, the predictions may be velocity vectors over a time period Δt (e.g., with a predetermined length such as 0.01, 0.02, 0.05, 0.1 seconds, etc.) in a Cartesian coordinate. In other embodiments, the predictions may be speed and angular velocity vectors over a time period Δt (e.g., with a predetermined length such as 0.01, 0.02, 0.05, 0.1 seconds, etc.) in a polar coordinate.

The loss function for training the deep learning model for predicting location and/or heading may be L1 loss, L2 loss, smooth L1 loss, Huber Loss, or any other regression loss functions between the predictions and the ground truth locations and/or headings. In some embodiments, the ground truth locations and/or headings may be the outputs of Visual Odometry (VO), Visual-Inertial Odometry (VIO), Lidar Odometry, RGBD or depth sensor based odometry. In other embodiments, the ground truth locations and/or headings may be the outputs of Simultaneously Localization and Mapping (SLAM) using monocular cameras, stereo cameras, IMUs, RGBD sensors, depth sensors, and/or Lidars. In other yet embodiment, the ground truth locations and/or headings may be provided by some ground truthing systems, like Vicon Motion Capture system, etc.

Given a location change in the Cartesian coordinate, a location at a current time instant is computed by the following equations (1), (2), and (3):

xₜ=x_{t-Δt}+Δx, (1)

yₜ=y_{t-Δt}+Δy, (2)

zₜ=z_{t-Δt}+Δz, (3)

where Δt is the time period over which the new location is computed/predicted, xₜ, yₜ, zₜ and x_{t-Δt}, y_{t-Δt}, z_{t-Δt} are the locations after and before the update, Δx, Δy, Δz are the location change, which may be the outputs of the network and may also be Δx=vₓΔt, Δy=v_{y}Δt, Δz=v_{z}Δt, where vₓ, v_{y}, v_{z} are the velocity vectors output by the network. In some embodiments, if only two dimensional coordinate is considered, then zₜ and its update may be ignored.

For a change or update in polar coordinate, a location at a current time instant is computed by the following equations (4), (5), and (6):

xₜ=x_{t-Δt}+Δl cos(Ψ_{t-Δt}+Δψ), (4)

yₜ=y_{t-Δt}+Δl sin(ψ_{t-Δt}+Δψ), (5)

ψₜ=ψ_{t-Δt}+Δψ, (6)

where Δt is the time period over which the new location and heading are computed/predicted, xₜ, yₜ, ψₜ, and x_{t-Δt}, y_{t-Δt}, y_{t-Δt} are the locations after and before the update, Δl, Δψ are the distance change and the heading change, which may be the outputs of the network and which may also be Δl=sₗΔt, Δψ=ω_{ψ}Δt, where sₗ and ω_{ψ} are speed and heading velocity output by the network.

FIGS. 2B-2E show examples of a network for predicting a location and heading of the computing device 104. As illustrated in FIGS. 2B-2E, p, q, r are the angular velocity in x, y, z axes of the body frame of the computing device 104, and aₓ, a_{y}, a_{z} are the acceleration in x, y, z axes of the body frame of the computing device 104, t_{w} is the time window during which all the IMU measurements up to a current time instant are inputs to the network to predict the location and/or heading of the computing device 104 (e.g., with a predetermined length such as 0.5, 1, 2 seconds, etc.). FIG. 2K shows a relation between the time window t_{w} and the time period Δt over which a location change or update, a distance change or update, a heading change, a velocity vector, or a speed and angular velocity vector may be predicted. As shown in FIG. 2K, the time window t_{w} and the time period Δt are different and the time window t_{w} can be longer than the time period Δt.

In some embodiments, the prediction module 126 may include another deep learning model to classify the predicted locations of the computing device 104 at different time instants, referred to as a classification model. For example, the classification model may be constructed using Recurrent Neural Network (RNN), Long Short Term Memory (LSTM), one dimensional Convolutional Neural Network (CNN), pooling, batch normalization, group normalization, layer normalization, dropout, fully connected layers, softmax, TCN, self-attention, transformer, and combinations of network architectures thereof. The loss function for training the classification model may be cross-entropy loss, negative log-likelihood loss, focal loss, Hinge loss, or any other classification losses between the predictions and the ground truth classes, which are either critical or non-critical.

FIGS. 2F and 2G show examples of a network for classifying whether a location is a critical point or non-critical point, where p, q, r are the angular velocity in x, y, z axes of the body frame of the computing device 104, and aₓ, a_{y}, a_{z} are the acceleration in x, y, z axes of the body frame of the computing device 104, t_{w} is the time window during which all the IMU measurements up to a current time instant are inputs to the network to classify the location to be a critical point or non-critical point (e.g., with a predetermined length such as 0.5, 1, 2 seconds, etc.).

In some embodiments, the prediction module 126 may use a single model for both predicting location or heading and classification. For example, one deep learning module may be used for the prediction of the location and/or heading and location classification. The model may be constructed using Recurrent Neural Network (RNN), Long Short Term Memory (LSTM), one dimensional Convolutional Neural Network (CNN), pooling, batch normalization, group normalization, layer normalization, dropout, fully connected layers, softmax, TCN, self-attention, transformer, and combinations of network architectures thereof.

In some embodiments, the predictions may be an absolute location and/or heading at a current time instant. In some embodiments, the predictions may be a location change or update over a time period Δt (e.g., with a predetermined length such as 0.01, 0.02, 0.05, 0.1 seconds, etc.) in a Cartesian coordinate. In some embodiments, the predictions may be a distance change or update and a heading change over a predetermined time period Δt (e.g., with a predetermined length such as 0.01, 0.02, 0.05, 0.1 seconds, etc.) in a polar coordinate. In some embodiments, the predictions may be velocity vectors over a time period Δt (e.g., with a predetermined length such as 0.01, 0.02, 0.05, 0.1 seconds, etc.) in a Cartesian coordinate. In some embodiments, the predictions may be speed and angular velocity vectors over a time period Δt (e.g., with a predetermined length such as 0.01, 0.02, 0.05, 0.1 seconds, etc.) in a polar coordinate. The loss function L for training the single prediction and classification model may be a weighted sum of a location and/or heading regression loss Ly and a classification loss L_{c}, which is given by L=wₗLₗ+w_{c}L_{c}, where wₗ and w_{c} are the weights for Lₗ and L_{c}.

FIGS. 2H and 2I show examples of a network for both prediction of a location and heading of the computing device 104 and classification of a location as critical point or non-critical point. As illustrated in FIGS. 2H and 2I, p, q, r are angular velocities in x, y, z axes of the body frame of the computing device 104, and aₓ, a_{y}, a_{z} are accelerations in x, y, z axes of the body frame of the computing device 104, t_{w} is the time window during which all the IMU measurements up to a current time instant are inputs to the network to predict the location and/or heading of computing device 104 and also to classify whether the location is a critical point or non-critical point (e.g., with a predetermined length such as 0.5, 1, 2 seconds, etc.).

Knowledge distillation (teacher-student model) may be used to facilitate training and distill knowledge. In some embodiments, the prediction module 126 may use knowledge distillation to train the model for predicting location and/or heading and classifying whether the location is the critical point, where a large pre-trained model is used during the training phase as a teacher model to distill its knowledge to the model used to perform predictions for location and/or heading and location classification in an inference time, referred to as a student model. The teacher model may be a deep neural network, such as RNN, LSTM, self-attention, CNN, TCN, transformer, or combination of these network architecture herein, which is pre-trained based on the data from monocular cameras, stereo cameras, Lidars, RGBD sensors, depth sensors, and IMU sensors and combination of these sensors thereof. For example, the teacher model may be a pre-trained deep neural network for visual-inertial odometry (VIO), visual odometry (VO), Lidar odometry, visual Simultaneously Localization and Mapping (SLAM), etc.

FIG. 2J shows an example for training the IMU-based model for predicting location and/or heading and location classification (student model) using knowledge distillation. As illustrated in FIG. 2J, a pre-trained VIO model, taking as inputs images from a monocular camera and IMU measurements, is used as the teacher model. The teacher model is not restricted to the VIO model with monocular cameras and IMU. In some embodiments, the teacher model may be a VO model with monocular cameras, a VO model with stereo cameras, a VIO model with stereo cameras and IMU, a model with Lidars, or the like.

In some embodiments, the loss function for training may be a sum of the distillation loss, difference between the teacher and student predictions, the student loss, difference between the student predictions and ground truth. In other embodiments, the loss function may be a weight sum of the distillation loss and the student loss, where the weights for both losses may be fixed at predetermined values or may be set online depending on how well the pre-trained teacher model and the student model performs. In some embodiment, the teacher model does not update its model parameters in the training process and is used for computing the distillation loss, distilling the knowledge to the student model in the training process. In addition, in the inference time, only the student model (e.g., the IMU-only model) is used.

In some embodiments, the location may be computed by double integration of the IMU measurements or by step counting approach with the assumption that a motion of the computing device 104 is fixed with respect to IMU measurements.

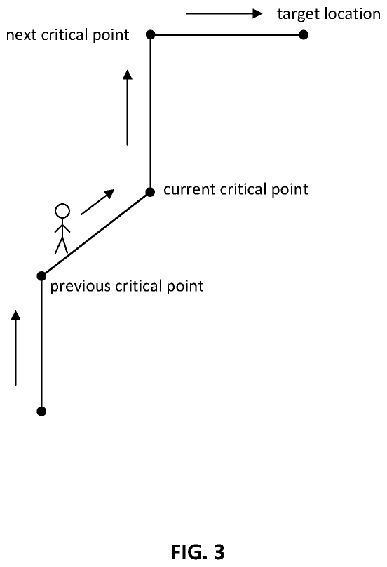

In the guidance mode, to guide the user 102 to a target location (e.g., a location the user 102 chooses to revisit) along a generated back route, the prediction module 126 may predict the location and/or heading of the computing device 104 with the user 102 at each time instant when the user 102 navigates back along the generated back route. In some embodiments, the prediction module 126 may use the same deep neural network as described above to perform prediction for: (i) an absolute location and/or heading, (ii) a location change or update, (iii) a distance and heading change or update, (iv) velocity vectors, or (v) speed and heading velocity. The network architecture may be any one of those shown in FIGS. 2B-2E, which are described above. The location and/or heading of the computing device 104 may be in the same coordinate system as the one defined in the mapping mode. In some embodiments, in the guidance mode, the prediction module 126 may use the predicted location of the computing device 104 as input to determine a location of the computing device 104 relative to a current critical point and/or a next critical point after the location and/or heading of the computing device 104 are predicted. FIG. 3 shows a previous critical point, a current critical point, a next critical point, and a target point on a back route along which the user 102 associated with the computing device 104 is moving. As shown in FIG. 3, a current critical point may be the critical point on the back route that the computing device 104 is currently moving toward. A next critical point may be the critical point that is next to and after the current critical point on the back route.

In other embodiments, in the guidance mode, the prediction module 126 may use a deep neural network to take IMU measurements as inputs to predict a location of the computing device 104 relative to a current critical point and/or a next critical point in the back route. For example, such a deep neural network may be constructed using Recurrent Neural Network (RNN), Long Short Term Memory (LSTM), one dimensional Convolutional Neural Network (CNN), pooling, batch normalization, group normalization, layer normalization, dropout, fully connected layers, TCN, self-attention, transformer, and combinations of network architectures herein.

In some embodiments, the prediction module 126 may store a set of locations in a time order as a historical trajectory or path of the user 102 or computing device 104, label critical points as critical, and label target points as targets. The critical points and target points may be stored in order to be used for navigation in the guidance mode. The critical points and target points may be stored into memory or saved into a file that may be loaded to the memory for use in the guidance mode.

The back route determination module 128 may generate a path or route back to a target location in a guidance mode. For example, the target location may be selected by a user 102. The target location may be referred to as a target point, a revisit location, a target revisit location, or the like, thereinafter. In some embodiments, the back route determination module 128 may cooperate with the user interaction module 122 to show options through a user interface for the user 102 to choose a target point among a list of stored revisit points he/she wants to revisit. In some embodiments, the user interaction module 122 may allow the user 102 to interact via voice to select a target point to revisit. In some embodiments, the back route determination module 128 may set by default the original point (home location) as the target point for the user 102 to go.

In some embodiments, in the guidance mode, the back route determination module 128 may merge a set of critical points that are close to each other, into one critical point. In some embodiments, the set of critical points may be merged using connected component based approaches for a specified threshold of the distance between two critical points. In other embodiments, the set of critical points may be merged using density based approaches, e.g., DBSCAN, etc. The resulting critical point may be the mean of the set of critical points that are merged.

In some embodiments, the back route determination module 128 may generate a graph based on the stored historical trajectory or path, critical points, and target points. For example, the graph may include multiple nodes and edges between the nodes. In some embodiments, the nodes of the graph may include the critical points and target points, and the edges of the graph between the nodes may include segments of the one or more stored historical trajectory or path. In some embodiments, the back route determination module 128 may determine an edge of the graph by determining connectivity between the critical points and/or target points. In some embodiments, the connectivity between the critical points and/or target points may be determined based on segments of the stored historical trajectory or path.

Based on the target point, the back route determination module 128 may extract from the generated graph an optimal route or path starting from the current location of the computing device 104 to the target point. In some embodiments, the optimal route or path may be the shortest route or path in the horizontal plane. In some embodiments, the optimal route or path may be the shortest route or path in three dimensional coordinate frame. In some embodiments, each edge of the graph may be given a weight based on its slope. Then, the optimal route or path may be the route or path leading to the minimum of weighted sum over the edges between the current location and the target point. An optimal route may include a current location of the computing device 104, one or more critical points, and a target point. An optimal path may include a current location of the computing device, one or more critical points, a target point, and segments of stored historical trajectory or path between critical points and between critical points and the target point based on the node connectivity. For ease and conciseness of description, a back path and a back route may be used interchangeably and an optimal path and an optimal route may be used interchangeably in this disclosure. However, their definitions may be slightly different as described above.

The critical point update module 130 may determine a switch from a current critical point to a next critical point, if the switch is determined, then updates the current critical point to the next critical path along the generated back route, to guide a user 102 to a target point based on the back route and the stored critical points. The critical point update module 130 may cooperate with the user interaction module 122 to guide the user to pass each critical point and eventually reach the target point. The current critical point is a stored critical point that the users 102 move towards in the back route, as shown in FIG. 3. The critical point update module 130 may determine a switch from a current critical point to a next critical point along the back route based on a current location of the user 102.

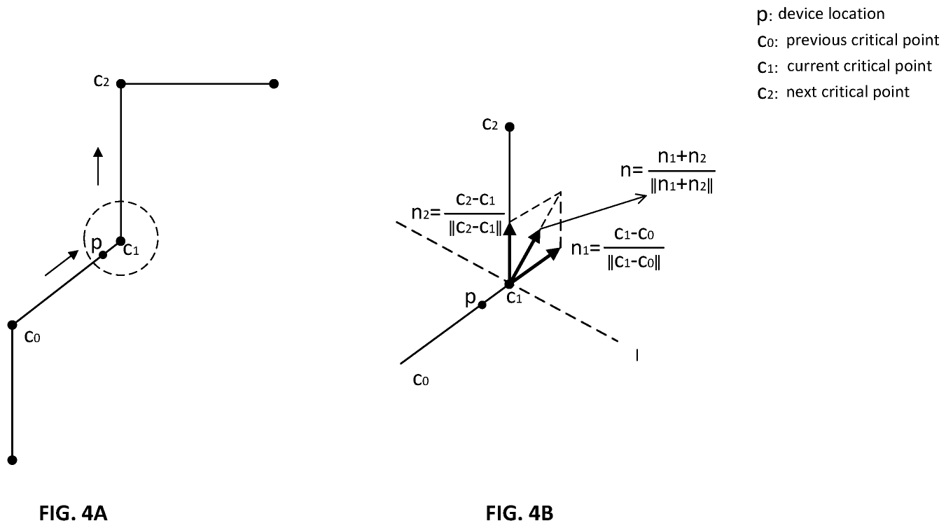

FIG. 4A shows an example for determining a switch from a current point to a next critical point based on a current location of the user and a current critical point. As shown in FIG. 4A, p represents the location of the computing device 104 associated with the user 102, c₀, c₁, and c₂ represent previous, current, and next critical points. As shown, determining a switch from a current critical point to a next critical point may include determining whether a current location of the computing device 104 associated with the user 102 p is close enough to the current critical point c₁ (e.g., within a pre-defined range such as within a half, one, two, five, ten, or other numbers of meters from the current critical point c₁).

In other embodiments, based on the location of the computing device 104 relative to the current critical point, and/or the next critical point, the critical point update module 130 may determine a switch from a current critical point to a next critical point based on geometry of the current location of the computing device of the user, the current critical point, and the next critical point.

FIG. 4B shows an example of criteria for determining a switch from a current critical point to a next critical point based on a geometry relationship among a current location of the computing device 104, a current critical point, and a next critical point. As shown in FIG. 4B, determining a switch from a current critical point to a next critical point may include determining whether a position relationship among a current location of the computing device 104 associated with the user 102, the current critical point, and the next critical point, which is the critical point next to and after the current critical point in the back route, satisfies certain geometry criteria. As shown in FIG. 4B, p represents the location of the computing device 104 associated with the user 102, c₀, c₁, and c₂ represent previous, current, and next critical points,

$${n}_{1} = \frac{{c}_{1} - {c}_{0}}{‖ {c}_{1} - {c}_{0} ‖} and {n}_{2} = \frac{{c}_{2} - {c}_{1}}{‖ {c}_{2} - {c}_{1} ‖}$$

represent the unit vector pointing to c₁ from c₀ and the unit vector pointing to c₂ from c₁, respectively, and

$$n = \frac{{n}_{1} + {n}_{2}}{‖ {n}_{1} + {n}_{2} ‖} .$$

If the user (or computing device 104) location p is in the half-plane bottom left from the dashed line l in FIG. 4B, i.e., p and c₁ satisfies (p−c₁)^{T}n<0, then c₁ is not passed by the user 102 and a switch has not yet occurred. If the user 102 (or computing device 104) location p enters the half-plane upper right from the dashed line l in FIG. 4B, i.e., (p−c₁)^{T}n≥0, then c₁ is passed by the user 102 and a switch has occurred. Therefore, the time instant of the switch from the current critical point c₁ to the next critical point c₂ may be determined as the first time instant when (p−c₁)^{T}n<0 changes to (p−c₁)^{T}n≥0.

In yet other embodiments, a machine learning or a deep learning model (e.g., a deep neural network model) may be used to determine a switch from a current critical point to a next critical point based on a current location of the user 102, one or more critical points (e.g., including, but not limited to, the current critical point, and/or the next critical point). In some embodiments, the critical point update module 130 may include a deep neural network to directly predict whether to switch from a current critical point to a next critical point and update the current critical point. Such a deep neural network may be constructed by fully connected network, multi-layer perceptron (MLP), Support Vector Machine (SVM), logistic regression, Recurrent Neural Network (RNN), Long Short-Term Memory (LSTM), one dimensional Convolutional Neural Network (CNN), Temporal Convolutional Network (TCN), self-attention, transformer, and combinations of these network architectures thereof. The input to the network for classifying whether to switch from a current critical point to a next critical point and update the current critical point may include the coordinates of the predicted current location of the user 102 or computing device 104 and the coordinate of one or more critical points in the back route, e.g., previous critical point that has been passed, current critical point that the user 102 or computing device 104 is moving towards, and/or the next critical point that is next to and after the current critical point in the back route, or any combination thereof.

In still other embodiments, the critical point update module 130 may use the anomaly detection to detect whether to switch from a current critical point to a next critical point. The anomaly detection model may be constructed from network architectures including but not limited to, softmax, support vector machine (SVM), generative adversarial network (GAN), logistic regression, multi-layer perceptron (MLP), Recurrent Neural Network (RNN), Long Short-Term Memory (LSTM), one dimensional Convolutional Neural Network (CNN), Temporal Convolutional Network (TCN), self-attention, transformer, and combinations thereof. The inputs to the anomaly detection model may include the coordinates of the predicted current location of the user 102 or computing device 104 and the coordinate of one or more critical points in the back route, e.g., previous critical point that has been passed, current critical point that the user 102 or computing device 104 is moving towards, and/or the next critical point that is next to and after the current critical point in the back route, or any combination thereof.

The critical point update module 130 may cooperate with the user interaction module 122 to generate instruction signals based on the determination of a switch from a current critical point to a next critical point and display or play the instruction signals to the user 102. As the critical points along the generated back route or path are passed one by one, The critical point update module 130 may cooperate with the user interaction module 122 to guide the user 102 to go back to the target point via voice. For example, when user 102 is passing the current critical point and a switch from a current critical point to a next critical point is determined, the instruction signals may include audio of “turn left”, “take the first/second/third route to the left”, “turn right”, “take the first/second/third route to the right”, or “go straight”, etc. In other embodiments, during the period of navigating back to a target historical location, the critical point update module 130 may cooperate with the user interaction module 122 to display the back route or path and current location in a user interface, which facilitates user's navigation.

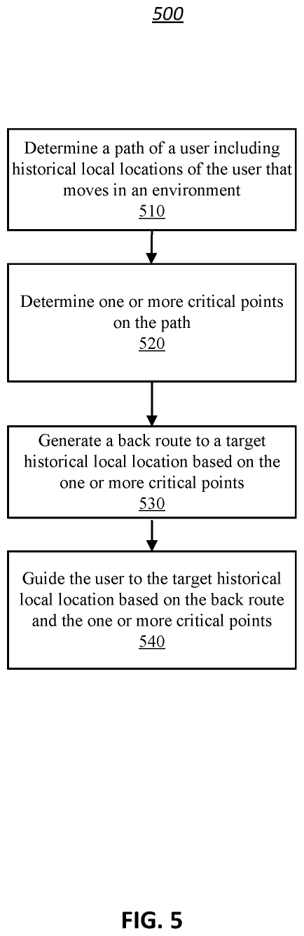

FIG. 5 illustrates a flowchart of an exemplary method 500 for local mapping, positioning, and guidance, according to various embodiments of the present disclosure. The method 500 may be implemented in various environments including, for example, the system 100 of FIG. 1. The exemplary method 500 may be implemented by one or more components of the system 100 (e.g., the computing device 104). The exemplary method 500 may be implemented by multiple systems similar to the system 100. The operations of method 500 presented below are intended to be illustrative. Depending on the implementation, the exemplary method 500 may include additional, fewer, or alternative steps performed in various orders or in parallel.

Δt block 510, a path of a user that moves in an environment may be determined. The determined path of the user may include a plurality of historical local locations of the user as the user is moving in the environment. For example, when the user is walking between different shops in a shopping mall, a path of the user may be determined, which may include multiple local locations at which the user has historically been.

Δt block 520, one or more critical points on the path of the user may be determined. For example, on the path of the user walking in the shopping mall, multiple locations that are critical to the navigation of the user may be determined, including, but not limited to, turning points, intersections of two or more routes, landmarks such as advertisement posters or panels, entertainment areas, facilities, etc.

Δt block 530, a back route to a target historical local location may be generated based on the one or more critical points. For example, a target historical local location may be selected by the user or determined as the original location of the user by default. The back route to the target historical local location may be generated by using the one or more critical points determined at block 520.

Δt block 540, the user may be guided to the target historical local location based on the back route and the one or more critical points. For example, the user may be provided a visual or audio instructions of navigating to the target local location. A current critical point on the back route may be determined based on a current location of the user. As the user moves along the back route, a switch from a current critical point to a next critical point may be determined and the current critical point may be updated. For example, when a switch from a current critical point to a next critical point is determined, a critical point on the back route next to and after the current critical point may be determined as the current critical point. Guidance or instructions may be provided to the user based on the current critical point.

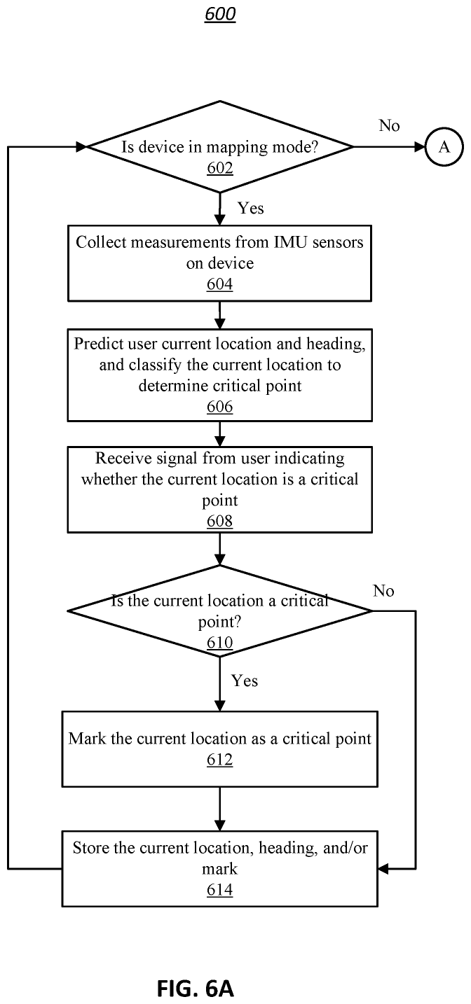

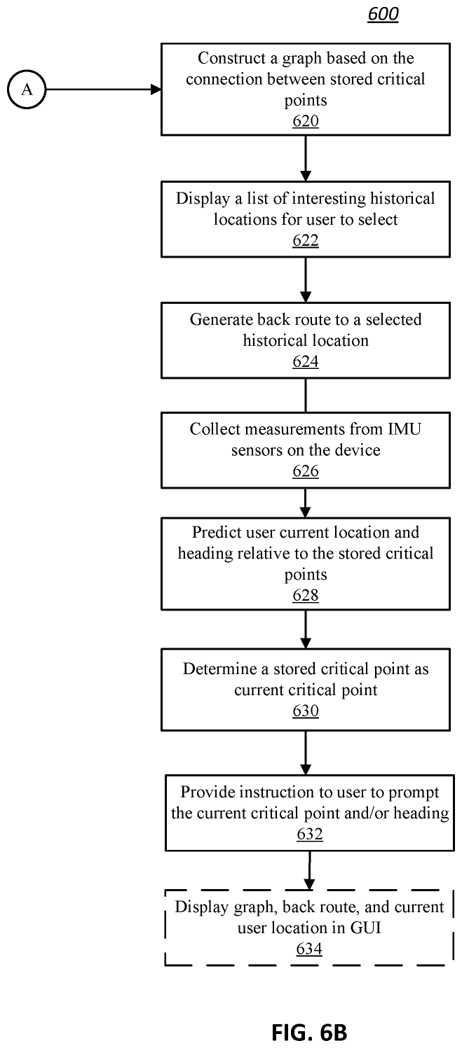

FIGS. 6A-6B illustrate a flowchart of another exemplary method 600 for local mapping, positioning, and guidance, according to various embodiments of the present disclosure. The method 600 may be implemented in various environments including, for example, the system 100 of FIG. 1. The exemplary method 600 may be implemented by one or more components of the system 100 (e.g., the computing device 104). The exemplary method 600 may be implemented by multiple systems similar to the system 100. The operations of method 600 presented below are intended to be illustrative. Depending on the implementation, the exemplary method 600 may include additional, fewer, or alternative steps performed in various orders or in parallel.

Referring to FIG. 6A, at block 602, it may be determined whether the device is in a mapping mode. For example, the computing device 104 may retrieve a mode signal from a user 102 associated with the computing device 104 through a GUI deployed on the computing device 104 or a motion of the computing device 104 caused by the user 102 and determine whether it is in a mapping mode based on the mode signal or the motion of the computing device 104. In other examples, the device 104 may operate in the mapping mode by default unless the device 104 receives a mode signal of guidance mode or a motion of the device 104 caused by the user 102 that indicates a guidance mode. If it is determined that the device is in a mapping mode, the method 600 proceeds to block 604; otherwise, the method 600 proceeds to block 620 as shown in FIG. 6B.

Δt block 604, measurements may be collected from IMU sensors on the device. For example, the measurements from IMU sensors may include velocity data and acceleration data of the device. The IMU data may measure a motion of the device. Δt block 606, a current location and heading of the user is predicted and classified to determine whether the current location is a critical point. For example, deep learning models may be used to predict the location and heading of the user and classifying the location to critical point or non-critical point. Δt block 608, a signal may be received from the user indicating whether the current location is a critical point. For example, the signal may be received through a motion of the device caused by the user or an input of the user to a GUI operating on the device.

Δt block 610, it may be determined whether the current location of the user is a critical point. For example, the current location of the user may be classified as a critical point by using a deep learning model or be indicated as a critical point by the received signal or input. If it is determined that the current location of the user is a critical point, the method 600 proceeds to block 612; otherwise, the method 600 proceeds to block 614. Δt block 612, the current location may be marked as a critical point. Δt block 614, the current location, heading, and/or a mark or label of critical point may be stored on the device.

Referring now to FIG. 6B, at block 620, a graph may be constructed based on connectivity between stored critical points. For example, the graph may include multiple nodes that are the critical points and edges between the nodes that are segments of a historical trajectory or path of the user. Δt block 622, a list of interesting historical locations may be displayed for the user to select. For example, a GUI may display multiple candidate historical locations that the user may be interested and selectable by the user as a target location. Δt block 624, a back route/path to a selected historical location may be generated. For example, after a selection of a historical location from the user is received, a back route may be generated to navigate the user to the selected historical location. In some embodiments, the back route may be displayed to the user visually or communicated to the user by audio.

Δt block 626, similar to block 604, measurements may be collected from IMU sensors on the device. For example, as the user moves along the back route to the selected historical location, velocity and acceleration date of the device may be collected from IMU sensors. Δt block 628, a user current location and heading relative to the stored critical points may be predicted. For example, at a current time instant, the user's location relative to the stored critical points along the back route may be calculated. Δt block 630, a stored critical point may be determined as a current critical point. For example, a stored critical point may be determined as a current critical point based on the current location of the user. In some embodiments, a switch from a current critical point to a next critical point may be determined and the current critical point is updated to a critical point next to and after the current critical point on the back route. In some embodiments, the predicted location may be off the path due to measurement error, the method 600 may receive the user's input of the accurate or actual location of the user, and use the input location as the current critical point. For example, the input may include indication of a switch from a current critical point to a next critical point.

Δt block 632, an instruction may be provided to the user to prompt the current critical point and/or heading. Δt block 634, optionally, the graph, back route, and the current user location may be displayed in a GUI for the user.

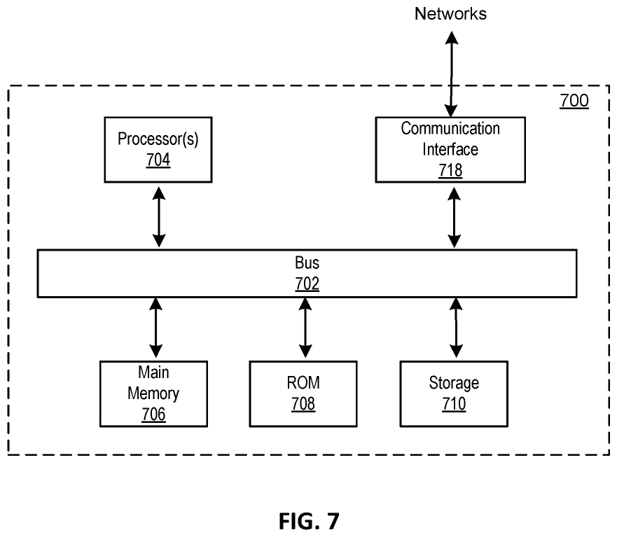

FIG. 7 is a block diagram that illustrates an exemplary computer system 700 in which any of the embodiments described herein may be implemented. The system 700 may correspond to the computing device 104 described above. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions. The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the operations, methods, and processes described herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The main memory 706, the ROM 708, and/or the storage 710 may include non-transitory storage media. The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 700 also includes a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic or optical signals that carry digital data streams representing various types of information.

The computer system 700 can send messages and receive data, including program code, through the network(s), network link and communication interface 718. In the Internet example, a server might transmit a requested code for an application program through the Internet, the ISP, the local network and the communication interface 718. The received code may be executed by processor 704 as it is received, and/or stored in storage device 710, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function, but can learn from training data to make a predictions model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A method for mapping, positioning, and guidance, implemented at a computing device, comprising:
determining a path of a user associated with the computing device, the path comprising a plurality of historical local locations of the user;
determining one or more critical points on the path;
generating a back route to a target historical local location based on the one or more critical points; and
guiding the user to the target historical local location based on the back route and the one or more critical points.

2. The method of claim 1, wherein the historical local locations of the user are described in a coordinate frame with an origin set at an original location of the user.

3. The method of claim 1, wherein determining a path of a user comprises:
retrieving measurement data from an IMU sensor on the computing device; and
estimating a location of the user based on the measurement data from the IMU sensor; and
generating the path of the user by using the estimated location as one of the historical local locations of the user.

4. The method of claim 3, wherein estimating a location of the user based on the measurement data from the IMU sensor comprises: inputting the measurement data from the IMU sensor to a deep learning model to predict the location and heading of the user.

5. The method of claim 3, wherein the estimated location of the user includes a location change over a time period, a heading change over the time period, a velocity vector over the time period, a speed and angular velocity vector over the time period, or any combination thereof.

6. The method of claim 1, wherein the one or more critical points include a location within a distance from an area where there are two or more options of traveling, a location within a distance from an area where a change of traveling direction is greater than a degree, a location within a distance from a landmark, or any combination thereof.

7. The method of claim 1, wherein determining one or more critical points on the path comprises:
classifying one of the historical local location as a critical point or a non-critical point by using a deep learning model.

8. The method of claim 1, wherein determining one or more critical points on the path comprises:
receiving measurement data from a sensor on the computing device, the measurement data describing a motion of the computing device; and
determining that the motion of the computing device indicates a current location of the user associated with the computing device is a critical point.

9. The method of claim 8, wherein the motion of the computing device comprises:
an up-to-down motion, a down-to-up motion, or a circular motion in a vertical plane parallel to a walking direction of the user; or
an up-to-down motion, a down-to-up motion, a left-to-right motion, a right-to-left motion, a triangular motion, a circular motion, or a rectangular motion in a vertical plane perpendicular to the walking direction of the user, a horizontal plane, or a plane with an angle from the walking direction of the user; or
any combinations thereof.

10. The method of claim 8, wherein determining that the motion of the computing device indicates a current location of the user associated with the computing device is a critical point comprises:
inputting the motion of the computing device to a deep learning model to classify whether the current location of the user associated with the computing device is a critical point.

11. The method of claim 1, wherein generating a back route to a target historical local location based on the one or more critical points comprises:
constructing a graph based on connectivity between the one or more critical points, the graph including the one or more critical points and the target historical local location as nodes; and
determining an optimal path to the target historical local location as the back route based on the graph.

12. The method of claim 1, wherein guiding the user to the target historical local location based on the back route and the one or more critical points comprises:
determining a switch from a current critical point to a next critical point based on a current location of the user relative to the current critical point; and
updating the current critical point with the next critical point on the back route when the switch is determined.

13. The method of claim 12, wherein determining a switch from the current critical point to a next critical point based on a current location of the user is based on a geometry relationship between the current location of the user and the current critical point meeting a criterion.

14. The method of claim 12, wherein determining a switch from the current critical point to a next critical point based on a current location of the user comprises: inputting the current location of the user, and one or more critical points along the back route into a deep learning model to classify whether to switch from the current critical point to the next critical point.

15. The method of claim 12, wherein determining a switch from the current critical point to a next critical point based on a current location of the user comprises:
predicting the current location of the user relative to the current critical point; and
determining the current critical point from the one or more critical points.

16. The method of claim 12, wherein guiding the user to the target historical local location based on the back route and the one or more critical points further comprises:
guiding the user to the target historical local location based on the current critical point.

17. The method of claim 1, further comprising:
determining a mapping mode or a guidance mode, wherein determining the path of the user associated with the computing device and determining one or more critical points on the path are performed in the mapping mode, and generating the back route to the target historical local location and guiding the user to the target historical local location are performed in the guidance mode.

18. The method of claim 17, wherein determining a mapping mode or a guidance mode comprises:
inputting a motion of the computing device into a deep learning model to classify whether the motion of the computing device indicates a mapping mode or a guidance mode.

19. An apparatus for mapping, positioning, and guidance, comprising
a processor; and
a non-transitory computer-readable storage medium storing instructions that, when executed by the processor, cause the apparatus to perform a method comprising:
determining a path of a user associated with the computing device, the path comprising a plurality of historical local locations of the user;
determining one or more critical points on the path;
generating a back route to a target historical local location based on the one or more critical points; and
guiding the user to the target historical local location based on the back route and the one or more critical points.

20. A non-transitory computer-readable storage medium storing instructions that, when executed by a processor, cause the processor to perform a method comprising:
determining a path of a user associated with the computing device, the path comprising a plurality of historical local locations of the user;
determining one or more critical points on the path;
generating a back route to a target historical local location based on the one or more critical points; and
guiding the user to the target historical local location based on the back route and the one or more critical points.
